(19) United States
(12) Patent Application Publication
(10) Pub. No.: US 2009/0299696 A1
(43) Pub. Date: Dec. 3, 2009

(54) DAMAGE PROBABILITY CALCULATING APPARATUS, DAMAGE PROBABILITY CALCULATING METHOD, MAINTENANCE METHOD, AND DAMAGE PROBABILITY CALCULATING PROGRAM

(75) Inventors: Hiromi SHIIHARA, Tokyo (JP); Shinsuke SAKAI, Tokyo (JP); Kunio TAGAMI, Akashi-shi (JP); Masataka YATOMI, Tokyo (JP); Yoshiharu SHIMURA, Yokohama-shi (JP); Masami HAMANO, Yokohama-shi (JP)

Correspondence Address: CANTOR COLBURN, LLP, 20 Church Street, 22nd Floor, Hartford, CT, 06103, US

(73) Assignee: NIPPON KAIJI KYOKAI, Tokyo (JP)

(21) Appl. No.: 12/345,573

(22) Filed: Dec. 29, 2008

(30) Foreign Application Priority Data
May 27, 2008 (JP) 2008-138036

(51) Int. Cl. G06F 17/18

(52) U.S. Cl. 702/181

(57) ABSTRACT

A damage probability calculating apparatus for calculating a damage probability of a specific estimation target includes: a storage unit 1 that stores a damage rate function representing a relationship between a damage rate and time; a damage rate function correcting unit 3 that corrects the damage rate function on the basis of examination data acquired at the time of general examination of the estimation target; and a damage probability calculating unit 4 that calculates the damage probability on the basis of the damage rate function corrected by the damage rate function correcting unit 3.

### BACKGROUND OF THE INVENTION

1. Field of the Invention

The invention relates to a damage probability calculating apparatus and a damage probability calculating method for calculating a damage probability of a specific evaluation target, a maintenance method for maintaining a specific evaluation target using a damage probability calculated by the damage probability calculating method, and a damage probability calculating program which instructs a computer to function as a means for calculating a damage probability of a specific evaluation target.

Priority is claimed on Japanese Patent Application No. 2008-138036, filed May 27, 2008, the content of which is incorporated herein by reference.

2. Description of Related Art

Recently, reasonable and economical maintenance have been performed based on RBM (Risk-Based Maintenance) by estimating risks of a plurality of estimation targets and preferentially examining a target with a high level of risk.

In the maintenance based on RBM, risk estimation of the estimation target is performed on the basis of a combination of the probability of any event (damage) occuring and the influence thereof. More specifically, risk estimation is performed by classifying estimation targets that are targets of maintenance using a risk matrix in which a vertical axis denotes damage probability and a horizontal axis denotes the influence of damage.

A damage probability used for risk estimation is calculated on the basis of a relational expression (damage rate function) representing the relationship between probability rate and time. Generally, a damage rate is based on a plurality of past damage data. That is, the damage probability used for risk estimation is calculated based on past damage data. However, the environment of an estimation target that is a target of risk estimation does not perfectly coincide with the environment of the past estimation target.

In Patent Document 1, a method was proposed in which when a defect (damage) occurs in an estimation target that is a target of risk estimation, the defect probability (damage probability) is recalculated on the basis of the occurring defect.

According to the method described in Patent Document 1, since the defect probability is recalculated on the basis of the defect occurring in the estimation target that is a target of actual risk estimation, it is possible to perform risk estimation using a defect probability more suitable for the estimation target that is a target of actual risk estimation. [Patent Document 1] Japanese Patent Application Laid-Open No.2007-328522

However, in the method described in Patent Document 1, it is difficult to calculate a new damage probability, as long as damage does not actually occur in an estimation target that is a target of risk estimation.

In actual situations, to realize more reasonable and economical maintenance, it is desired to perform risk estimation using a damage probability more applicable to an estimation target that is a target of actual risk estimation, before damage actually occurs.

### SUMMARY OF THE INVENTION

The invention has been made to solve the aforementioned problem, and an object of which is to make it possible to perform risk estimation on the basis of a damage probability more applicable to an actual estimation target, even before damage actually occurs in an estimation target that is a target of risk estimation.

The invention employs the following configurations as means for solving the aforementioned problems.

According to a first aspect of the invention, there is provided a damage probability calculating apparatus for calculating the damage probability of a specific estimation target, the apparatus including: a storage unit that stores a damage rate function representing the relationship between damage rate and time; a damage rate function correcting unit that corrects the damage rate function on the basis of examination data acquired at the time of general examination of the estimation target; and a damage probability calculating unit that calculates the damage probability on the basis of the damage rate function corrected by the damage rate function correcting unit.

According to the first aspect of the invention with such a configuration, the damage rate function of the estimation target is corrected on the basis of the examination data acquired at the time of the general examination of the estimation target, and the damage probability is calculated on the basis of the corrected damage rate function.

According to a second aspect of the invention, in the first aspect of the invention, the damage rate function correcting unit calculates the likelihood with respect to a coefficient included in the damage rate function on the basis of the examination data, and corrects the damage rate function by correcting the coefficient by the likelihood on the basis of Bayes' theorem.

According to a third aspect of the invention, in the second aspect of the invention, the damage rate function correcting unit corrects only the coefficient, change in value of which has the greatest influence on the damage rate function, by the likelihood, when the damage rate function includes a plurality of coefficients.

According to a fourth aspect of the invention, in any one of the first to third aspects of the invention, the damage probability calculating apparatus further includes a damage rate function calculating unit that calculates the damage rate function from past damage data.

According to a fifth aspect of the invention, there is provided a damage probability calculating method for calculating a damage probability of a specific estimation target, the method including: calculating a damage rate function representing a relationship between a damage rate and time; correcting the damage rate function on the basis of examination data acquired at the time of general examination of the estimation target; and calculating the damage probability on the basis of the damage rate function corrected by the correcting of the damage rate function.

According to the fifth aspect of the invention with such a configuration, the damage rate function of the estimation target is corrected on the basis of the examination data acquired at the time of the general examination of the estimation target, and the damage probability is calculated on the basis of the corrected damage rate function.

According to a sixth aspect of the invention, in the fifth aspect of the invention, in the correcting of the damage rate function, the likelihood with respect to a coefficient included in the damage rate function is calculated on the basis of the examination data, and the damage rate function is corrected by correcting the coefficient by the likelihood on the basis of Bayes' theorem.

According to a seventh aspect of the invention, in the sixth aspect of the invention, in the correcting of the damage rate function, only the coefficient, change in value of which has the greatest influence on the damage rate function, is corrected by the likelihood, when the damage rate function includes a plurality of coefficients.

According to an eighth aspect of the invention, there is provided a maintenance method for estimating risk with respect to a specific estimation target on the basis of the damage probability of the specific estimation target and the affect of damage caused by the damage of the specific estimation target and maintaining the specific estimation target on the basis of the risk, wherein the risk is estimated using the damage probability calculated by the damage probability calculating method according to any one of the fifth to seventh aspects of the invention.

According to a ninth aspect of the invention, there is provided a damage probability calculating program for causing a computer to function as a means of calculating the damage probability of a specific estimation target, the program causing the computer to function as: storage means for storing a damage rate function representing the relationship between damage rate and time; a damage rate function correcting means for correcting the damage rate function on the basis of examination data acquired at the time of general examination of the estimation target; and damage probability calculating means for calculating the damage probability on the basis of the damage rate function corrected by the damage rate function correcting means.

According to the ninth aspect of the invention with such a configuration, the damage rate function of the estimation target is corrected on the basis of the examination data acquired at the time of the general examination of the estimation target, and the damage probability is calculated on the basis of the corrected damage rate function.

According to a tenth aspect of the invention, in the ninth aspect of the invention, the program causes the computer to function as the damage rate function correcting means to calculate a likelihood with respect to a coefficient included in the damage rate function on the basis of the examination data, and to correct the coefficient by the likelihood on the basis of Bayes' theorem.

According to an eleventh aspect of the invention, in the tenth aspect of the invention, the program causes the computer to function as the damage rate function correcting means to correct only the coefficient, change in value of which has the greatest influence on the damage rate function, by the likelihood, when the damage rate function includes a plurality of coefficients.

According to a twelfth aspect of the invention, in any one of the ninth to eleventh aspects of the invention, the program causes the computer to function as a damage rate function calculating means for calculating the damage rate function from past damage data.

According to the invention, the damage rate function of the estimation target is corrected on the basis of the examination data acquired at the time of the general examination of the estimation target, and the damage probability is calculated on the basis of the corrected damage rate function.

For this reason, even when no damage occurs in the estimation target at the general examination, the damage rate function of the estimation target is corrected and the damage probability is calculated on the basis of the corrected damage rate function.

Therefore, according to the invention, even before damage actually occurs in the estimation target that is a target of risk estimation, it is possible to perform risk estimation on the basis of damage probability more suitable for an actual estimation target.

### BRIEF DESCRIPTION OF THE DRAWINGS

FIG. 1 is a block diagram illustrating a functional configuration of a damage probability calculating apparatus according to an embodiment of the invention.

FIG. 2 is a flowchart for describing a damage probability calculating method according to an embodiment of the invention.

FIG. 3 is a graph for describing a damage rate function correcting method with a damage probability calculating method according to an embodiment of the invention.

### DETAILED DESCRIPTION OF THE INVENTION

Hereinafter, an embodiment of a damage probability calculating apparatus, a damage probability calculating method, a maintenance method, and a damage probability calculating program according to the invention will be described with reference to the drawings.

In the following description, it is assumed that an estimation target of the invention is a cylinder cover provided in a main machinery of a ship by way of example.

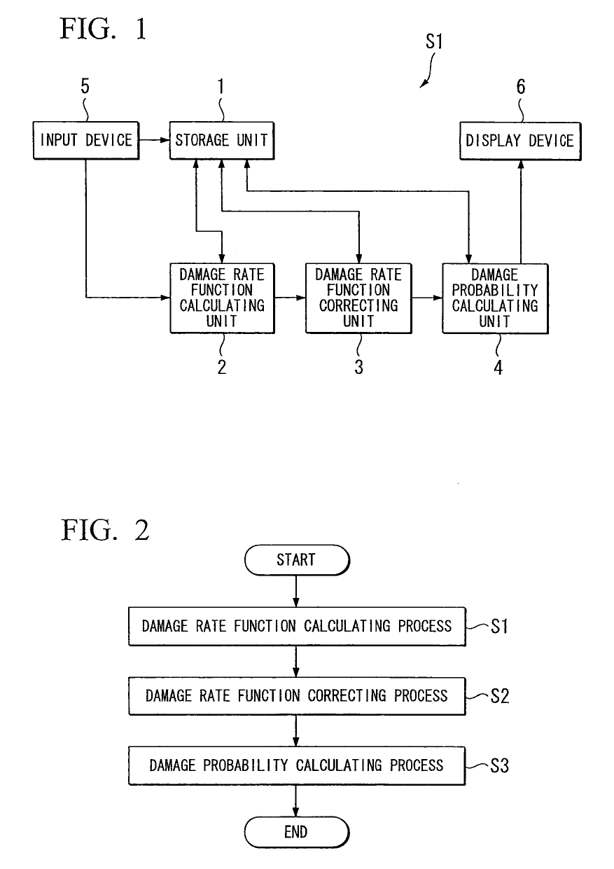

FIG. 1 is a block diagram illustrating a functional configuration of a damage probability calculating apparatus S1 according to the embodiment. As shown in FIG. 1, the damage probability calculating apparatus S1 according to the embodiment includes a storage unit 1, a damage rate function calculating unit 2, a damage rate function correcting unit 3, a damage probability calculating unit 4, an input device 5, and a display device 6. In actual, the storage unit 1 is formed of a memory, a hard disk, or the like. The damage rate function calculating unit 2, the damage rate function correcting unit 3, and the damage probability calculating unit 4 are formed of an arithmetic processing unit such as a CPU.

The storage unit 1 stores programs for controlling operations of the damage probability calculating apparatus S1 according to the embodiment or various types of data.

The storage unit 1 of the damage probability calculating apparatus S1 according to the embodiment stores damage data related to a past cylinder cover. Herein, the past cylinder cover is not limited to a cylinder cover that is a target for calculating a damage probability by the damage probability calculating apparatus S1 according to the embodiment, and also includes damage data of a past cylinder cover or the like provided in another ship.

The storage unit 1 stores a calculation expression and a damage rate function (the relationship between a damage rate and time) used to calculate a damage probability.

In the embodiment, since the damage rate function is calculated in the damage rate function calculating unit 2, the storage unit 1 stores the damage rate function calculated by the damage rate function calculating unit 2. However, when the damage rate function is calculated from the outside of the damage probability calculating apparatus S1, the storage unit 1 previously stores the damage rate function.

The damage data of the past cylinder cover stored in the storage unit 1 is used to calculate the damage rate function. For this reason, when the damage rate function is stored in the storage unit 1 in advance, it is not necessary that the storage unit 1 store the damage data of the past cylinder cover.

The storage unit 1 stores examination data acquired at the time of general examination carried out for the cylinder cover for calculating a damage probability by the damage probability calculating apparatus S1 according to the embodiment.

Herein, the general examination is examination carried out after a predetermined period and is examination preformed even when a cylinder cover is not damaged.

The examination data stored in the storage unit 1 is input to the storage unit 1 through the input device 5, and includes the time of examination, the existence of damage, and the state of damage.

The damage rate function calculating unit 2 calculates a damage rate function on the basis of the damage data of the past cylinder cover stored in the storage unit 1.

Specifically, the damage data of the past cylinder cover stored in the storage unit 1 includes the time when damage occurs. Accordingly, for example, the damage rate function calculating unit 2 calculates an occurring rate of damage (damage rate) every time, time-serially arranges the occurring rate, and further calculates a damage rate curve. The damage rate curve is represented by numerical expression, and the numerical expression is a damage rate function. Such a damage rate function is a relational expression representing the relationship between damage rate and time, and is represented as a function including at least one coefficient that is a probability variable.

The damage rate function correcting unit 3 corrects the damage rate function stored in the storage unit 1 in the same manner on the basis of the examination data stored in the storage unit 1.

Specifically, the damage rate function correcting unit 3 calculates a likelihood with respect to the coefficient included in the damage rate function on the basis of the examination data, and corrects the damage rate function by correcting the coefficient with the calculated likelihood using Bayes' theorem.

The Bayes' theorem is a theorem for calculating a post-probability (damage rate function after correction) from a pre-probability (damage rate function before correction) on the basis of any obtained result (examination data). The Bayes' theorem has been known to the public, and thus a detailed description thereof herein is omitted.

When the damage rate function includes a plurality of coefficients, the damage rate function correcting unit 3 of the damage probability calculating apparatus S1 according to the embodiment calculates a likelihood with respect to only a coefficient (hereinafter, referred to as a maximum contribution coefficient), change in value of which has the greatest influence on the damage rate function, and corrects only the maximum contribution coefficient on the basis of the calculated likelihood.

In the damage probability calculating apparatus S1 according to the embodiment, a configuration of correcting only the maximum contribution coefficient is employed to contrive efficiency in calculation operation, but all coefficients may be corrected in an environment where prompt calculation is possible. A predetermined number of coefficients may be corrected in order to have greater influence on the damage rate function by change in value of the plurality of coefficients.

The damage probability calculating unit 4 calculates the damage probability of the cylinder cover using the calculation expression stored in the storage unit 1, based on the damage rate function (including both of the damage rate function before correction and the damage rate function after correction).

Before the damage rate function is corrected in the damage rate function correcting unit 3, the damage probability calculating unit 4 calculates the damage probability of the cylinder cover on the basis of the damage rate function before correction. After the damage rate function is corrected in the damage rate function correcting unit 3, the damage probability calculating unit 4 calculates the damage probability of the cylinder cover based on the damage rate function after correction.

The input device 5 is operated by a worker when necessary data is input to the damage probability calculating apparatus S1 according to the embodiment, and is formed of a keyboard or a mouse.

The examination data acquired at the time of examination of the cylinder cover or the like is input through the input device 5. The input device 5 is used to input various types of data necessary for the damage probability calculating apparatus S1 according to the embodiment, in addition to the examination data.

The display device 6 visually displays the damage probability calculated in the damage probability calculating unit 4, and is formed of a display or a printer.

The display device 6 displays various types of data needing to be visualized in the damage probability calculating apparatus S1 according to the embodiment, in addition to the damage probability.

Next, an operation (damage probability calculating method) of the damage probability calculating apparatus S1 configured according to the embodiment described above will be described with reference to a flowchart shown in FIG. 2.

As shown in FIG. 2, the damage probability calculating method according to the embodiment includes a damage rate function calculating process (Step S1), a damage rate function correcting process (Step S2), and a damage probability calculating process (Step S3).

The damage rate function calculating process (Step S1) is a process for calculating the damage rate function representing the relationship between a damage rate and time. In the damage rate function calculating process (Step S1), the damage rate function calculating unit 2 calculates a damage rate function on the basis of the damage data of the past cylinder cover stored in the storage unit 1.

When a damage rate function is actually calculated on the basis of the damage data of the past cylinder cover, the damage rate function λ (damage rate (%)/time (year)) is represented by an exponential function shown in the following expression (1), as a function of time T.

Accordingly, in the damage probability calculating method according to the embodiment, the expression (1) is calculated as a damage rate function.

The damage rate function X calculated in the damage rate function calculating process (Step S1) is stored in the storage unit 1.

Expression (1)

λ(T)=aexp(bT) (t>0) (1)

Subsequently, the damage rate function correcting process (Step S2) is a process for correcting the damage rate function calculated in Step S1, on the basis of examination data acquired at the time of general examination of the cylinder cover that is a target for calculating a damage probability. In the damage rate function correcting process (Step S2), the damage rate function correcting unit 3 corrects the damage rate function stored in the storage unit 1 in the same manner, on the basis of the examination data stored in the storage unit 1.

In the damage probability calculating method according to the embodiment, the damage rate function λ shown in the expression (1) includes two coefficients of a and b. These two coefficients are probability variables representing dispersion of the damage data stored in the storage unit 1. The coefficient a, a change in value of which has the greatest influence on the damage rate function λ, between the two coefficients is considered to be the maximum contribution coefficient and is accepted as a probability variable. The coefficient b, a change in value of which has little influence on the damage rate function λ, is accepted as a fixed value.

In case of a>0, the coefficient a is a probability variable using normal distribution in which the average value of the coefficient a is aₘ and a standard deviation thereof is σₐ.

The relationship between the damage rate function λ(T) and the damage probability F(T) that is a damage probability to T year can be represented by the following expression (2). The damage probability F(T) can be represented by the following expression (3) from the expression (2).

$$\begin{matrix}Expression ( 2 ) & \\ λ ( T ) = \frac{{F}^{′} ( T )}{1 - F ( T )} & ( 2 ) \\ Expression ( 3 ) & \\ F ( T ) = 1 - exp ( - \frac{a}{b} exp ( bT ) ) & ( 3 )\end{matrix}$$

Since health of the cylinder cover in the initial state is confirmed, the following expression (4) is represented in case of T>0.

$$\begin{matrix}Expression ( 4 ) & \\ {F}_{0} ( T ) = \frac{F ( T ) - F ( 0 )}{1 - F ( 0 )} = 1 - exp [ - \frac{a}{b} \{ exp ( bT ) - exp ( b 0 ) \} ] & ( 4 )\end{matrix}$$

From the expression (4), for example, a probability, in which no damage is discovered within 5 years, is represented by the following expression (5), and a probability, in which no damage is discovered within 10 years and damage is discovered in the 15th year, is represented by the following expression (6).

Expression (5)

{1−F(5)}/{1−F(0)} (5)

Expression (6)

{F(15)−F(10)}/{1−F(0)} (6)

Accordingly, the expression (5) or the expression (6) can be accepted as a likelihood [l(a)] with respect to the damage variable a, and it is possible to correct the coefficient a by Bayes' theorem.

In this case, assuming that an i-th examination is carried out in the Tᵢ-th year by general examination, an average value of a is presented by aₘ_{_{—}}ᵢ₋₁, a standard deviation thereof is represented by σₐ_{_{—}}ᵢ₋₁, and aₘ_{_{—}}₀ and σₐ_{_{—}}₀ are initial values.

When no damage is discovered up to an i−1-th general examination (Tᵢ₋₁-th year) and in addition no damage is discovered at the i-th general examination (Tᵢ-th year), a likelihood lᵢ(a) of the i-th general examination is represented by the following expression (7).

$$\begin{matrix}Expression ( 7 ) & \\ {l}_{i} ( a ) = \frac{1 - F ( {T}_{i} )}{1 - F ( {T}_{i - 1} )} & ( 7 )\end{matrix}$$

In this case, a likelihood up to the i-th is represented by the following expression (8).

$$\begin{matrix}Expression ( 8 ) & \\ {\prod }_{j = 1}^{i} {l}_{j} ( a ) = \frac{1 - F ( {T}_{i} )}{1 - F ( 0 )} = 1 - {F}_{0} ( T ) & ( 8 )\end{matrix}$$

When no damage is discovered up to an i-1-th general examination (Tᵢ₋₁-th years) and damage is discovered at i-th general examination (Tᵢ-th years), a likelihood lᵢ(a) of the i-th general examination is represented by the following expression (9).

$$\begin{matrix}Expression ( 9 ) & \\ {l}_{i} ( a ) = \frac{F ( {T}_{i} ) - F ( {T}_{i - 1} )}{1 - F ( {T}_{i - 1} )} & ( 9 )\end{matrix}$$

Since the likelihood up to the i−1-th is represented in the expression (4), a likelihood up to the i-th is represented by the following expression (10).

$$\begin{matrix}Expression ( 10 ) & \\ {\prod }_{j = 1}^{i} {l}_{j} ( a ) = \frac{F ( {T}_{i} ) - F ( {T}_{i - 1} )}{1 - F ( 0 )} = {F}_{0} ( {T}_{i} ) - {F}_{0} ( {T}_{i - 1} ) & ( 10 )\end{matrix}$$

As described above, a likelihood according to the examination result is calculated on the basis of the examination data of the general examination. The coefficient a is corrected on the basis of the calculated likelihood, and further the damage rate function is corrected.

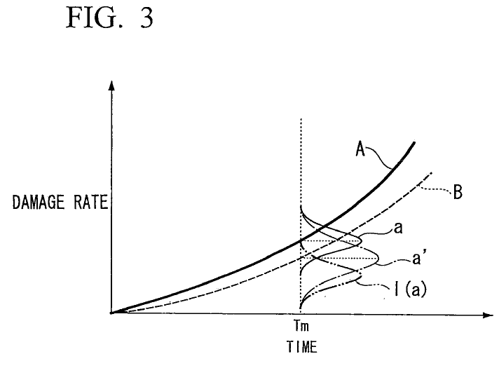

The correction of the damage rate function performed in the damage rate function correcting process (Step S2) will be described with reference to the graph shown in FIG. 3. In FIG. 3, a horizontal axis indicates time, and a vertical axis indicates a damage rate.

As shown in FIG. 3, the coefficient a is a probability variable and has distribution, and the damage rate function before correction has an average curve represented as a graph A passing through the average value of the coefficient a before correction at the time Tm of general examination. In the damage probability calculating method according to the embodiment, the coefficient a with the likelihood l(a) calculated at the time Tm of the general examination is corrected using the Bayes' theorem. As a result, a coefficient a′ that is the coefficient a after correction has an average value moved from the coefficient a before correction. For this reason, the damage rate function has an average curve represented as a graph B passing through the average value of the coefficient a (coefficient a′) after correction at the time Tm of the general examination. Thus, the graph B becomes the corrected damage rate function.

Subsequently, the damage probability calculating process (Step S3) is a process for calculating a damage probability on the basis of the damage rate function corrected in the damage rate function correcting process (Step S2). In the damage probability calculating process (Step S3), the damage probability calculating unit 4 calculates a damage probability of the cylinder cover using the calculation expression stored in the storage unit 1. The damage probability calculating unit 4 calculates a damage probability of the cylinder cover on the basis of the expression (2) and the expression (3).

In the case of calculating the damage probability, it is necessary to consider how maintenance is performed on the cylinder cover. That is, it is necessary to make the time axis of the damage rate function and the time axis of reality deviate from each other.

More specifically, as can be known from the expression (2) and the expression (3), to calculate the damage probability of the cylinder cover at any period, it is possible to calculate the damage probability by integrating the damage rate function corresponding to any period. In this case, it is thought that a damage probability from Tᵢ-th year to Tⱼ-th year is calculated in the actual time.

When the cylinder cover has not been exchanged, the time axis of the damage rate function and the time axis of the reality coincide with each other. Accordingly, a starting point (Tₘₐᵢₙₜ) of the integration becomes Ti in the damage rate function, as shown in the following expression (11). For this reason, an accumulated using time (Tₜₒₜₐₗ) of the cylinder cover that is a calculation target of the damage probability, that is, an ending point of the integration becomes Tⱼ, as shown in the following expression (12).

Expression (11)

Tₘₐᵢₙₜ=Tᵢ (11)

Expression (12)

Tₜₒₜₐₗ=Tₘₐᵢₙₜ+(Tⱼ−Tᵢ)=Tⱼ (12)

When the cylinder cover is replaced with a cylinder cover that has already been used during the period of calculating the damage probability, the time axis of the damage rate function and the time axis of the reality do not coincide with each other and the starting point (Tₘₐᵢₙₜ) of the integration becomes Tₖ in the damage rate function, as shown in the following expression (13). For this reason, an accumulated using time (Tₜₒₜₐₗ) of the cylinder cover that is a target of the damage probability, that is, an ending point of the integration becomes Tⱼ−Tᵢ+Tₖ as shown in the following expression (14).

Expression (13)

Tₘₐᵢₙₜ=Tₖ (13)

Expression (14)

Tₜₒₜₐₗ=Tₘₐᵢₙₜ+(Tⱼ−Tᵢ)=Tⱼ−T+ᵢTₖ (14)

When the cylinder cover is replaced with a new cylinder cover during the period of calculating the damage probability, the time axis of the damage rate function and the time axis of the reality do not coincide with each other and the starting point (Tₘₐᵢₙₜ) of the integration becomes T₀ (original point) in the damage rate function, as shown in the following expression (15). For this reason, an accumulated operating time (Tₜₒₜₐₗ) of the cylinder cover that is a target of the damage probability, that is, an ending point of the integration becomes Tⱼ−Tᵢ as shown in the following expression (16).

Expression (15)

Tₘₐᵢₙₜ=T₀ (15)

Expression (16)

Tₜₒₜₐₗ=Tₘₐᵢₙₜ+(Tⱼ−Tᵢ)=Tⱼ−Tᵢ (16)

When the cylinder cover is replaced or exchanged during the period of calculating the damage probability as described above, the time axis of the damage rate function and the time axis of the reality deviate from each other, in accordance with the period of the placing or exchanging and the usage completion period of the replaced cylinder cover. Therefore, it is possible to accurately calculate the damage probability of the cylinder cover from the Tᵢ-th year to the Tⱼ-th year.

Next, generalization of likelihood calculation will be described.

It is assumed that the present year is mₙ-th and maintenance has been performed in the period from m₁-th year to mₙ-th year. In this case, a total likelihood is represented by the following expression (17).

$$\begin{matrix}Expression ( 17 ) & \\ {\prod }_{j = 1}^{{m}_{n}} {l}_{j} ( a ) = {\prod }_{j = 1}^{{m}_{1}} {l}_{j} ( a ) {\prod }_{j = {m}_{1} + 1}^{{m}_{2}} {l}_{j} ( a ) … {\prod }_{j = {m}_{i} + 1}^{{m}_{i + 1}} {l}_{j} ( a ) … {\prod }_{j = {m}_{n - 1} + 1}^{{m}_{n}} {l}_{j} ( a ) & ( 17 )\end{matrix}$$

Each value of the right side integrated in the expression (17) is generalized as the following expression (18).

$$\begin{matrix}Expression ( 18 ) & \\ {\prod }_{j = {m}_{i} + 1}^{{m}_{i + 1}} {l}_{j} ( a ) = \frac{Num ( i )}{Den ( i )} & ( 18 )\end{matrix}$$

Herein, when the mᵢ-th maintenance is performed without the replacing and exchanging of the cylinder cover, the following expression (19) is represented. When the mᵢ-th maintenance is performed with the replacing, the following expression (20) is represented. When the mᵢ-th maintenance is performed with the exchanging, the following expression (21) is represented.

Expression (19)

Tₘₐᵢₙₜ₋ᵢ=Tₘ_{ᵢ} (19)

Expression (20)

Tₘₐᵢₙₜ₋ᵢ=Tₖᵢ_{ᵢ} (20)

Tₖᵢ_{ᵢ} denotes the number of using years of the cylinder cover replaced in the mᵢ-th maintenance.

Expression (21)

Tₘₐᵢₙₜ₋ᵢ=T₀=0 (21)

In this case, the denominator in the expression (18) is represented by the following expression (22).

Expression (22)

Den(i)=1−F(Tₘₐᵢₙₜ₋ᵢ) (22)

The numerator is classified as follows in accordance with the mᵢ₊₁-th examination result.

When the mᵢ₊₁-th examination result is not a problem, the numerator is represented by the following expression (23). When the mᵢ₊₁-th examination result is damage after 3 years, the numerator is represented by the following expression (24). When the mᵢ₊₁-th examination result is damage, the numerator is represented by the following expression (25).

Expression (23)

Num(i)=1−F(Tₘₐᵢₙₜ₋ᵢ+Tₘ_{ᵢ₊₁}−Tₘ_{ᵢ}) (23)

Expression (24)

Num(i)=F(Tₘₐᵢₙₜ₋ᵢ+Tₘ_{ᵢ₊₁}−Tₘ_{ᵢ}+3)−F(Tₘₐᵢₙₜ₋ᵢ+Tₘ_{ᵢ₊₁}₋₁−Tₘ_{ᵢ}) (24)

Expression (25)

Num(i)=F(Tₘₐᵢₙₜ₋ᵢ+Tₘ_{ᵢ₊₁}−Tₘ_{ᵢ})−F(Tₘₐᵢₙₜ₋ᵢ+Tₘ_{ᵢ₊₁}₋₁−Tₘ_{ᵢ}) (25)

As described above, the likelihood calculation is generalized.

According to the damage probability calculating apparatus and the damage probability calculating method of the embodiment, the damage rate function with respect to the cylinder cover is corrected on the basis of the examination data acquired at the time of general examination of the cylinder cover that is an estimation target, and the damage probability is calculated on the basis of the corrected damage rate function.

For this reason, even when no damage occurs in the cylinder cover at the general examination, the damage rate function of the cylinder cover is corrected and the damage probability is calculated on the basis of the corrected damage rate function.

Therefore, according to the damage probability calculating apparatus and the damage probability calculating method of the embodiment, even before damage actually occurs in the cylinder cover that is a target of risk estimation, it is possible to perform risk estimation on the basis of a damage probability more suitable for the presently used cylinder cover.

When risk with respect to the cylinder cover is estimated on the basis of the damage probability of the cylinder cover and the influence caused by the damage of the cylinder cover and the maintenance of the cylinder cover is performed on the basis of the risk, it may be possible to extend the period of the maintenance of the cylinder cover by calculating the damage probability of the cylinder cover using the damage probability calculating method described above.

That is, in the general examination of the cylinder cover, when no damage is discovered in the cylinder cover, inclination of the damage rate function becomes gentle by correction, as shown in FIG. 3. As a result, the damage probability decreases, and the risk is reduced. Accordingly, the period of the maintenance of the cylinder cover is extended.

When the above-described damage probability calculating apparatus is a computer, a program for causing the computer to function as the storage unit 1 (storage means), the damage rate function calculating unit 2 (damage rate function calculating means), the damage rate function correcting unit 3 (the damage rate function correcting means), and the damage probability calculating unit 4 (damage probability calculating means) is stored in the computer, and then the damage probability calculating apparatus may be realized by executing the program.

Such a program is stored in a recording media or a storage device on network, and is installed in the computer through a drive device or network.

The preferred embodiment of the damage probability calculating apparatus, the damage probability calculating method, the maintenance method, and the damage probability calculating program has been described with reference to the accompanying drawings, but the invention is not limited to the above-described embodiment. All of the types and combinations of the constituent elements described in the embodiment are an example, and may be variously modified within the main concept of the invention on the basis of design requirements or the like.

For example, in the above-described embodiment, the estimation target of the invention is the cylinder cover of the engine provided in the ship.

However, the invention is not limited thereto, and may be used to calculate a damage probability of any target such as devices or components, the risk to which is to be estimated.

In the above-described embodiment, the damage rate function is corrected using Bayes' theorem on the basis of the examination data.

However, the invention is not limited thereto, and the damage rate function may be corrected using another method on the basis of the examination data.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A damage probability calculating apparatus for calculating a damage probability of a specific estimation target, the apparatus comprising:
a storage unit that stores a damage rate function representing the relationship between a damage rate and time;
a damage rate function correcting unit that corrects the damage rate function on the basis of examination data acquired at the time of general examination of the estimation target; and
a damage probability calculating unit that calculates the damage probability on the basis of the damage rate function corrected by the damage rate function correcting unit.

2. The damage probability calculating apparatus according to claim 1, wherein the damage rate function correcting unit calculates a likelihood with respect to a coefficient included in the damage rate function on the basis of the examination data, and corrects the damage rate function by correcting the coefficient by the likelihood on the basis of Bayes' theorem.

3. The damage probability calculating apparatus according to claim 2, wherein the damage rate function correcting unit corrects only the coefficient, a change in value of which has the greatest influence on the damage rate function, by the likelihood, when the damage rate function includes a plurality of coefficients.

4. The damage probability calculating apparatus according to claim 1, further comprising a damage rate function calculating unit that calculates the damage rate function from past damage data.

5. A damage probability calculating method for calculating a damage probability of a specific estimation target, the method comprising:
calculating a damage rate function representing the relationship between a damage rate and time;
correcting the damage rate function on the basis of examination data acquired at the time of general examination of the estimation target; and
calculating the damage probability on the basis of the damage rate function corrected by the correcting of the damage rate function.

6. The damage probability calculating method according to claim 5, wherein in the correcting of the damage rate function, a likelihood with respect to a coefficient included in the damage rate function is calculated on the basis of the examination data, and the damage rate function is corrected by correcting the coefficient by the likelihood on the basis of Bayes' theorem.

7. The damage probability calculating method according to claim 6, wherein in the correcting of the damage rate function, only the coefficient, a change in value of which has the greatest influence on the damage rate function, is corrected by the likelihood, when the damage rate function includes a plurality of coefficients.

8. A maintenance method for estimating risk with respect to a specific estimation target on the basis of a damage probability of the specific estimation target and influence caused by the damage of the specific estimation target and maintaining the specific estimation target on the basis of the risk, wherein the risk is estimated using the damage probability calculated by the damage probability calculating method according to claim 5.

9. A damage probability calculating program for causing a computer to function as a means for calculating a damage probability of a specific estimation target, the program causing the computer to function as:
storage means for storing a damage rate function representing the relationship between a damage rate and time;
damage rate function correcting means for correcting the damage rate function on the basis of examination data acquired at the time of general examination of the estimation target; and
damage probability calculating means for calculating the damage probability on the basis of the damage rate function corrected by the damage rate function correcting means.

10. The damage probability calculating program according to claim 9, wherein the program causes the computer to function as the damage rate function correcting means to calculate a likelihood with respect to a coefficient included in the damage rate function on the basis of the examination data, and to correct the coefficient by the likelihood on the basis of Bayes' theorem.

11. The damage probability calculating program according to claim 10, wherein the program causes the computer to function as the damage rate function correcting means to correct only the coefficient, a change in value of which has the greatest influence on the damage rate function, by the likelihood, when the damage rate function includes a plurality of coefficients.

12. The damage probability calculating program according to claim 9, wherein the program causes the computer to function as a damage rate function calculating means for calculating the damage rate function from past damage data.

13. A damage probability calculating program comprising:
calculating a damage rate function representing the relationship between a damage rate and time;
correcting the damage rate function on the basis of examination data acquired at the time of general examination of the estimation target; and
calculating the damage probability on the basis of the damage rate function corrected by the correcting of the damage rate function.

14. The damage probability calculating program according to claim 13, wherein in the correcting of the damage rate function, a likelihood with respect to a coefficient included in the damage rate function is calculated on the basis of the examination data, and the damage rate function is corrected by correcting the coefficient by the likelihood on the basis of Bayes' theorem.

15. The damage probability calculating program according to claim 14, wherein in the correcting of the damage rate function, only the coefficient, a change in value of which has the greatest influence on the damage rate function, is corrected by the likelihood, when the damage rate function includes a plurality of coefficients.

16. The damage probability calculating program according to claim 13, comprising calculating the damage rate function from past damage data.

17. The damage probability calculating apparatus according to claim 2, further comprising a damage rate function calculating unit that calculates the damage rate function from past damage data.

18. The damage probability calculating apparatus according to claim 3, further comprising a damage rate function calculating unit that calculates the damage rate function from past damage data.

19. A maintenance method for estimating risk with respect to a specific estimation target on the basis of a damage probability of the specific estimation target and influence caused by the damage of the specific estimation target and maintaining the specific estimation target on the basis of the risk, wherein the risk is estimated using the damage probability calculated by the damage probability calculating method according to claim 6.

20. A maintenance method for estimating risk with respect to a specific estimation target on the basis of a damage probability of the specific estimation target and influence caused by the damage of the specific estimation target and maintaining the specific estimation target on the basis of the risk, wherein the risk is estimated using the damage probability calculated by the damage probability calculating method according claim 7.

21. The damage probability calculating program according to claim 10, wherein the program causes the computer to function as a damage rate function calculating means for calculating the damage rate function from past damage data.

22. The damage probability calculating program according to claim 11, wherein the program causes the computer to function as a damage rate function calculating means for calculating the damage rate function from past damage data.

23. The damage probability calculating program according to claim 14, comprising calculating the damage rate function from past damage data.

24. The damage probability calculating program according to claim 15, comprising calculating the damage rate function from past damage data.
